(19) United States
(12) Patent Application Publication
(10) Pub. No.: US 2022/0295167 A1
(43) Pub. Date: Sep. 15, 2022

(54) Smart Head-Mounted Device

(71) Applicant: Goertek Inc., Weifang, Shandong (CN)

(72) Inventors: Tongyan Xu, Weifang (CN); Chengxiang Zhai, Weifang (CN)

(73) Assignee: Goertek Inc., Weifang, Shandong (CN)

(21) Appl. No.: 17/635,184

(22) PCT Filed: Dec. 26, 2019
(86) PCT No.: PCT/CN2019/128556

§ 371 Date: Feb. 14, 2022

(30) Foreign Application Priority Data
Aug. 14, 2019 (CN) 201910749783.6

(51) Int. Cl. H04R 1/10; H04R 1/34; H04R 1/28; G02C 11/00

(52) U.S. Cl. CPC H04R 1/1008; H04R 1/345; H04R 1/1075; H04R 1/288; G02C 11/10

(57) ABSTRACT

Disclosed is a smart head-mounted device, comprising: at least one lens and at least one arm; the arm includes a fixed section and a cooperating section, the fixed section being connected to the lens at one end thereof, the cooperating section being formed as an extension of the fixed section from the other end thereof, the cooperating section functions as an earpiece having a curvature; and a sound production apparatus provided inside the fixed section and provided with a sound outlet, at least part of a structure of the sound outlet facing an area surrounded by the cooperating section, and the sound outlet being configured to guide a sound out; the sound outlet is positioned to avoid direct contact with the ear of the user and is apart from an ear hole of the user by a predetermined distance when the user wears the smart head-mounted device

### CROSS-REFERENCE TO RELATED APPLICATIONS

This application is a National Stage of International Application No. PCT/CN2019/128556, filed on Dec. 26, 2019, which claims priority to Chinese Patent Application No. 201910749783.6, filed Aug. 14, 2019 both of which are hereby incorporated by reference in their entireties.

### TECHNICAL FIELD

The present disclosure relates to the field of wearable device, and particularly to a smart head-mounted device.

### BACKGROUND

In the prior art, a sound playback component of a smart head-mounted device such as smart glasses is in an in-ear structure, for example, commonly used earbuds which are hermetically coupled to ear holes of an user.

Nevertheless, an earbud that has been worn for a long time is prone to cause discomfort in an ear canal of its user. For example, an earbud tends to cause sweating during sports activities of the user, causing bacteria to grow between the earbuds and the ear canals; at the same time, it becomes difficult for the user to hear surrounding sounds when he or she wears the earphone, increasing risk factors during exercise. The existing solution is to use a bone conduction sound production apparatus; however, the bone conduction sound production apparatus has poor sound quality, especially poor low-frequency sound quality, and its vibration easily causes discomfort of the user during wearing.

Therefore, there is a need to provide a simple-structured smart head-mounted device that can provide high-quality audio.

### SUMMARY

An object of the present disclosure is to provide a smart head-mounted device.

According to a first aspect of the present disclosure, a smart head-mounted device is provided, comprising:
at least one lens and at least one arm, the arm including a fixed section and a cooperating section, the fixed section being connected to the lens at one end thereof, the cooperating section being formed as an extension of the fixed section from the other end thereof, the cooperating section having a curvature and being, configured to hang on an ear of an user; and
a sound production apparatus provided inside the fixed section, the sound production apparatus being provided with a sound outlet, at least a part of a structure of the sound outlet facing an area surrounded by the cooperating section, and the sound outlet being configured to guide a sound out of the sound production apparatus;
the sound outlet is positioned to avoid direct contact with the ear of the user and is apart from an ear hole of the user by a predetermined distance when the user wears the smart head-mounted device, the predetermined distance being greater than or equal to 0.5 cm.

Optionally, the predetermined distance ranges from 0.5 cm to 0.6 cm.

Optionally, the predetermined distance ranges from 2 cm to 4 cm.

Optionally, the fixed section has a longitudinal height greater than that of the cooperating section, with an end surface formed at one end thereof close to the cooperating section for smooth connection with the cooperating section.

Optionally, the sound outlet is a strip-shaped slit, with at least a part of the sound outlet extending the end surface;

or, the sound outlet is a round hole or an oval hole.

Optionally, an axis of the sound outlet is configured to form an angle ranging from 0° to 5° measured from a line connecting a center point of the sound outlet and the ear hole.

Optionally, the fixed section is formed with a cavity therein, the cavity is in communication with the sound outlet and is provided with the sound production apparatus inside; the sound production apparatus divides the cavity into a back acoustic cavity and a front acoustic cavity in communication with the sound outlet, and the back acoustic cavity is provided with a sound-adsorbing material inside.

Optionally, the arm is provided with a main sound leakage hole and is formed with a cavity therein, the cavity is in communication with the sound outlet and is provided with the sound production apparatus inside; the sound production apparatus divides the cavity into a back acoustic cavity and a front acoustic cavity in communication with the sound outlet, and the main sound leakage hole is in communication with the back acoustic cavity.

Optionally, the main sound leakage hole is positioned in the arm in such a way that a distance between the main sound leakage hole and the ear hole of the user of the smart head-mounted device is greater than a distance between the sound outlet and the ear hole of the user.

Optionally, the arm is further provided with an auxiliary sound leakage hole in communication with the back acoustic cavity, and the auxiliary sound leakage hole is positioned in the arm in such a way that a distance between the auxiliary sound leakage hole and the ear hole of the user of the smart head-mounted device is greater than the distance between the main sound leakage hole and the ear hole of the user.

The beneficial effects of the present invention are that in the smart head-mounted device provided by the present disclosure, by providing the sound production apparatus on the arm, it is possible to realize the open-coupling between the sound production apparatus and the ear hole, and solve the problems such as a series of harm to the ear hole and the ear canal caused by wearing the earbuds for a long time in the prior art.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 shows a structural diagram of a smart head-mounted device of the present disclosure.

FIG. 2 shows a partial view of the smart head mounted device shown in FIG. 1 of the present disclosure.

FIG. 3 is a structural diagram of the smart head-mounted device of the present disclosure from another view.

FIG. 4 shows a cross-sectional view of a partial structure of the smart head-mounted device of the present disclosure.

FIG. 5 is a structural diagram of another embodiment of the smart head-mounted device of the present disclosure.

### DETAILED DESCRIPTION

Various exemplary embodiments of the present disclosure will now be described in detail with reference to the accompanying drawings. It should be noted that the relative arrangement, numerical expressions and numerical values of the components and steps set forth in these examples do not limit the scope of the disclosure unless otherwise specified.

The following description of at least one exemplary embodiment is in fact merely illustrative and is in no way intended as a limitation to the present disclosure and its application or use.

Techniques, methods, and apparatus known to those of ordinary skill in the relevant art may not be discussed in detail but where appropriate, the techniques, methods, and apparatus should be considered as part of the description.

Among all the examples shown and discussed herein, any specific value should be construed as merely illustrative and not as a limitation. Thus, other examples of exemplary embodiments may have different values.

It should be noted that similar reference numerals and letters denote similar items in the accompanying drawings, and therefore, once an item is defined in a drawing, and there is no need for further discussion in the subsequent accompanying drawings.

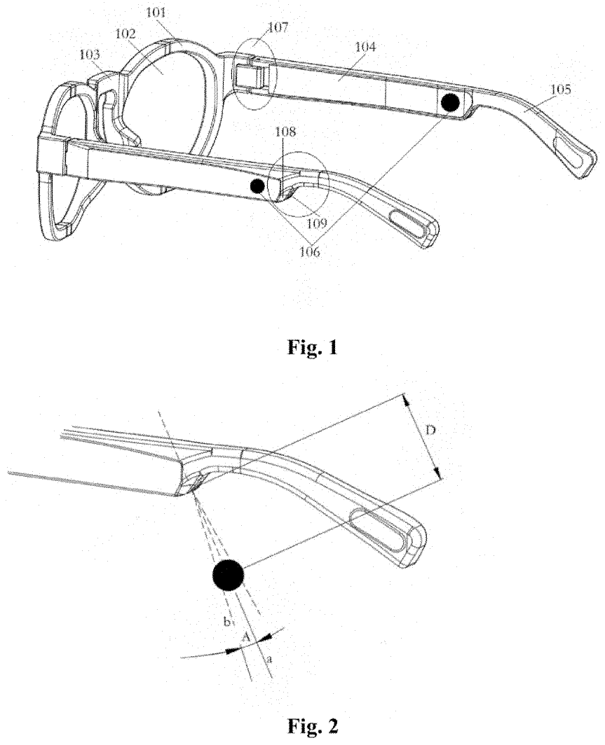

According to an embodiment of the present disclosure, a smart head-mounted device is provided. FIG. 1 shows a structure diagram of the smart head-mounted device of the present embodiment. As shown in FIG. 1, the smart head-mounted device includes at least one lens 102, at least one arm and a sound production apparatus.

The arm includes a fixed section 104 and a cooperating section 105, wherein one end of the fixed section 104 is connected to the lens.

Optionally, the arm is directly connected to the lens through a connecting piece; one end of the connecting piece is fixedly connected to the lens 102, for example, a pin can be used for fixed connection; the other end of the connecting piece is movably connected to the arm, for example, the arm can be bent relative to the connecting piece, that is, the arm can be bent at a certain angle relative to the lens. With the present embodiment, it is possible to reduce a storage space for the smart head-mounted device and it is convenient for the user to carry.

Optionally, the smart head-mounted device further includes a frame 101, wherein the frame 101 is used to fix the at least one lens 102, and is movably connected to the arm through the connecting piece 107. For example, the arms can be bent relative to the connecting piece, that is, the arms can be bent at a certain angle relative to the lens.

Optionally, the connecting member 107 includes card slots and cards fixed within the card slot. The arm is configured to be bent with respect to the connecting piece. Specifically, the card slots are respectively provided on the arm and the frame, and the cards are fixed within the card slot, wherein the card slot provided on the arm is pivotally connected to the card.

Specifically, the frame 101 includes a left frame and a right frame, wherein the left frame fixes a left lens and the right frame fixes a right lens.

Optionally, the frame 101 surrounds the lens 102 and is fixed to the lens 102 by a snap connection.

Optionally, the frame 101 surrounds a part of the lens 102. For example, the frame 101 is as half-frame structure which is only fixedly connected to a part of the lens.

Optionally, the frame 101 only contacts edges or a part of the edges of the lens 102.

Optionally, the frame may fix a plurality of lenses. For example, the left frame fixes a plurality of lenses which are laminated polarized lenses, and one of the laminated polarized lenses can rotate relative to the other lenses.

Optionally, the left frame and the right frame are connected by a nose frame 103.

The arm includes a fixed section 104 and a cooperating section 105, wherein the fixed section 104 is connected to the lens 102 at one end thereof, and extends at the other end thereof to form the cooperating section 105 having a curvature. The cooperating section 105 curves to extend a distance, thereby semi-encircling, semi-surrounding a portion of the space. The cooperating section 105 is used to hang on an ear of the user, so as to fix the smart head-mounted device on the head of the user.

Optionally, the cooperating section 105 is provided with a pad on the surface contacting the ear of the user so as to improve the comfort of the user when wearing the smart head-mounted device.

Optionally, the fixed section 104 and the cooperating section 105 may be integrally formed or separately formed. To “separately form” is to manufacture the fixed section 104 and the cooperating section 105 separately, and to connect the fixed section 104 and the cooperating section 105 mechanically after the fixed section 104 and the cooperating section 105 are completed. For example, the fixed section 104 and the cooperating section 105 are connected by a binge or the like, and the cooperating section 105 may be bent at a certain angle with respect to the fixed section 104. For example, the cooperating section 105 may be bent to be overlapped with the fixed sections 104. In this embodiment, the smart head-mounted device may be folded, thereby reducing the storage space of the smart head-mounted device.

The sound production apparatus is provided on the arm. For example, the sound production apparatus is provided inside the fixed section 104. The fixed section 104 is provided with a sound outlet 109 configured to guide the sound out of the sound production apparatus. At least a part of the structure of the sound outlet needs to face the area surrounded by the cooperating section. In this way, the sound transmitted from the sound outlet may be transmitted toward the ear holes of the user.

In a specific optional embodiment, the sound production apparatus is provided at as position of the fixed section 104 close to the cooperating section 105. The fixed section 104 and the cooperating, section 105 have different sizes, and at the position where they are connected, may be formed with an end surface 108 facing the area surrounded by the cooperating section. At least a part of the area of the sound outlet 109 extends to the end surface 108, so as to guide sound to the ear holes. As shown in FIG. 1, the installation position 106 of the sound production apparatus and the position of the sound outlet 109 are shown.

Optionally, the fixed section 104 has a longitudinal height greater than that of the cooperating section 105, and at one end thereof close to the cooperating section 105, is formed with an end surface 108. The end surface 108 is smoothly connected to the cooperating section 105, and in particular, is smoothly connected to a surface of the cooperating section 105 contacting the ear, thereby improving the comfort of the user when wearing the smart head-mounted device.

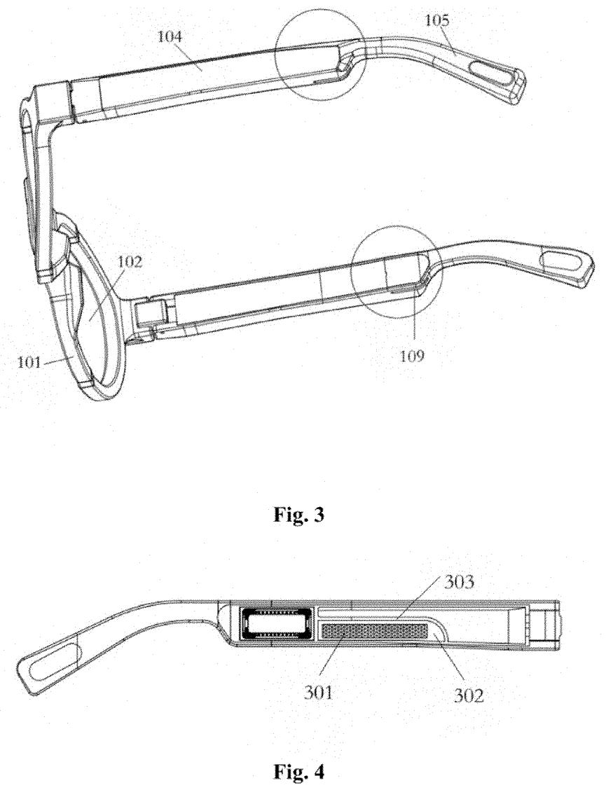

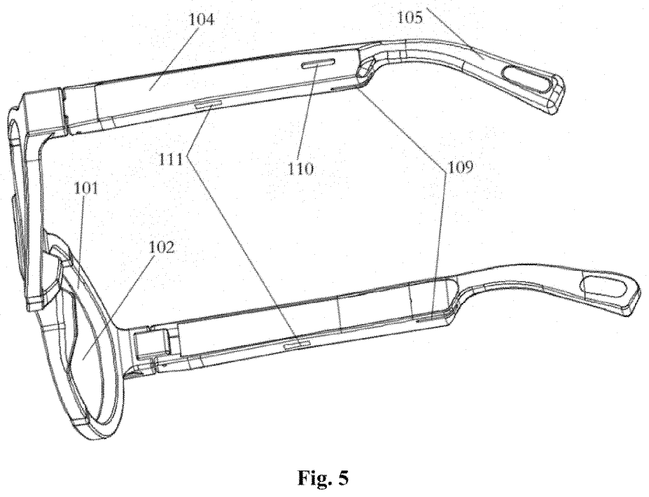

The sound outlet 109 is in a strip shape. As shown in FIG. 3, one end of the sound outlet 109 is provided on the end surface 108, and the other end thereof extends to a surface of the fixed section smoothly connected to the end surface 108.

Wherein, the surface smoothly connected to the end surface 108 may be the inner side surface of the fixed section 104 (a surface of the fixed section close to the face of the user in the lateral direction when the user wears the smart head-mounted device), or may be the lower surface of the fixed section 104 (a surface of the fixed section close to the face of the user in the longitudinal direction when the user wears the smart head-mounted device) and the like.

Optionally, the sound outlet 109 may also be a round hole or an elliptical hole.

In the smart head-mounted device provided by the present disclosure, the sound outlet 109 is not in direct contact with the ear and skin of the user, but transmits sound waves to the ear holes of the user through air vibration. The position of the sound outlet is set such that when the user wears the smart head-mounted device, a predetermined distance is left between the sound outlet arid the ear holes of the user, and the predetermined distance is greater than or equal to 0.5 cm.

In this embodiment, the sound production apparatus is provided on the arm, thereby realizing the open-coupling between the sound production apparatus and the ear holes. Compared with the hermetical coupling in the prior art, the present disclosure avoids problems such as the hearing loss of the ear and the proliferation of bacteria in the ear canal caused by the long-term wearing of earbuds by the user; at the same time, the end surface 108 of the fixed section 104 of the present disclosure close to the cooperating section 105 is provided with a sound outlet 109 configured to guide and transmit the sound of the sound production apparatus.

The inventor found that in the structure of the smart head-mounted device, preferably, the “end surface”is a position relatively close to the ear hole of the user, and does not hinder the normal use of the smart head-mounted device. Therefore, when the sound made by the sound production apparatus is transmitted through the sound outlet 109 and enters the ear hole, the loudness and sound quality of the sound production apparatus is not be affected due to the long-distance transmission, and therefore the user may hear high-quality sound.

Optionally, the fixed section 104 is formed with a cavity at a position close to the cooperating section 105, wherein the cavity is in communication with the sound outlet and is provided with the sound production apparatus inside; the sound production apparatus divides the cavity into a back acoustic cavity 302 and a front acoustic cavity in communication with the sound outlet, and the back acoustic cavity 302 is provided with sound-adsorbing material 301 inside.

The fixed section 104 is provided with a partition 303 inside, and the partition 303 extends toward the end where the fixed section 104 is connected to the lens, and is enclosed to form the back acoustic cavity 302.

The back acoustic cavity 302 is in a rectangular, oval or irregular shape. For example, as shown in FIG. 4, the back acoustic cavity 302 is in a long strip shape whose one end is in an arc shape.

Optionally, the sound-adsorbing material is selected from at least one of sound-adsorbing cotton and sound-adsorbing particles.

When the sound-adsorbing material is the sound-adsorbing cotton, the sound-adsorbing cotton has a shape that matches the structure of the back acoustic cavity 302 and is fixed to the back acoustic cavity 302 by bonding.

Optionally, the sound-adsorbing cotton is made of melamine and formed by a hot pressing process. The inventor found that when the sound-adsorbing cotton is formed by the hot pressing process, it has a relatively dense texture and a good sound-adsorbing effect.

When the sound-adsorbing material is sound-adsorbing particles, since the sound-adsorbing particles are in powder form, the sound-adsorbing particles separately arranged in the back acoustic cavity 302 enter the sound production apparatus under the condition of poor sealing, thereby affecting its performance and life. Therefore, in order to solve this technical problem, the present disclosure encapsulates the sound-adsorbing particles in the following specific method.

Optionally, the sound-adsorbing particles is arranged inside a sound-adsorbing shell, and the sound-adsorbing shell is provided with an isolation net sealed to the sound-adsorbing shell and is fixedly connected with the back acoustic cavity. The sound-adsorbing shell is made of at least one of metal material or plastic material. Or, an accommodating cavity divided by the isolation net is directly formed in the back acoustic cavity, and the sound-adsorbing particles are filled into the accommodating cavity through a filling port. Besides, an isolation net is provided on the back sound outlet of the sound production apparatus, so that the sound-adsorbing material may be freely filled in the entire back acoustic cavity.

In this embodiment, due to the design of the structure and size of the smart head-mounted device, the sound-adsorbing material 301 is arranged in the back acoustic cavity 302, which reduces the resonance frequency F0 of the sound production apparatus and improves the low-frequency sound quality and low-frequency sensitivity of the sound production apparatus; at the same time, the sound-adsorbing material 301 increases a virtual space of the back acoustic cavity 302 of the sound production apparatus.

The sound-adsorbing material of the present embodiment expands the equivalent volume of the back acoustic cavity 302 of the sound production apparatus, so that the smart head-mounted device can provide better low-frequency sound quality.

In this embodiment, due to the design of the structure of the arm, it can be considered that the cavity and the sound outlet are arranged at a position close to the ear hole. The present disclosure realizes the multi-functionalization of the smart head-mounted device, and at the same time improves the sound quality of the sound production apparatus. Compared with the prior art in which a bone conduction sound production apparatus is provided on the smart head-mounted device, the present disclosure has higher adaptability, In addition, in the bone conduction sound production apparatus, the sounding patch needs to be tightly attached to a partial skull of the user, however, sounding patches have different degree of adhesion since the partial skull may be different among the users, which affects the sound effect of the sound production apparatus. The present disclosure has completely overcome this defect, and by designing the position of the sound production apparatus, the present disclosure improves the sound quality of the audio heard by the user.

Wherein, the outer diameter of the sound production apparatus is the outer side wall of the sound production apparatus closest to the diaphragm of the sound production apparatus.

Regarding the above-mentioned technical feature of the distance between the sound outlet 109 and the ear hole of the user, that is, the predetermined distance, the present disclosure provides alternative embodiments. By adjusting the position of the sound outlet on the arm, the predetermined distance can be controlled. Preferably, when the user wears the smart head-mounted device, the linear distance D between the sound outlet 109 and the ear hole ranges from 0.5 cm to 6 cm. For example, the range of the linear distance D between the sound outlet 109 and the ear hole is 3 cm. The inventor found that the aforementioned predetermined distance may affect the loudness of the audio heard by the user. When the predetermined distance D ranges from 2 cm to 4 cm, the audio heard by the user has moderate loudness. Especially, during outdoor activities, the predetermined distance within the above distance range not only enables the user to enjoy high-quality audio (audio with moderate loudness and clear sound quality), but also enables the user to hear outside sounds within a certain decibel range, such as a vehicle horn, which reduces the risk factor of the user during outdoor activities.

According to an embodiment of the present disclosure, as shown in FIGS. 2 and 3, the sound outlet 109 is in a strip shape, wherein the angle between the axis direction of the sound outlet 109 and a line a connecting the center point of the sound outlet 109 and the ear hole ranges from 0° to 5°. The inventor found that within this angle range, the sound production apparatus has the best mid-frequency and high-frequency effects, and the best sound quality. Whether the sound production apparatus is used to play music or to play movies, it can achieve high-quality sound quality.

Wherein, the center point of the sound outlet 109 is the center point of the cross section of the sound outlet structure; wherein, preferably, the center point of the sound outlet 109 is the center point of the end of the sound outlet structure closest to the sound production apparatus.

As shown in FIG. 2 the linear position of the axis of the sound outlet 109 is a dashed line b, and the line connecting the center point of the sound outlet 109 and the ear hole is a dashed line a.

The inventor found that when the dashed line b and the dashed line a are on a straight line, that is, when the angle is 0°, the mid-to-high frequency sound of the sound production apparatus is transmitted to the ear hole, and the user can hear high-quality mid-to-high frequency sound quality. However, when the axis direction of the sound outlet 109 is offset relative to the line connecting the sound production apparatus and the ear hole, the mid-to-high frequency attenuation of the sound wave of the sound production apparatus is not severe if the offset angle is not beyond 5°, and when the mid-to-high frequency sound wave of the sound production apparatus is transmitted into the ear holes of the user, the user can also hear high-quality mid-to-high frequency sound quality.

When the axis of the sound outlet 109 is offset to the left with respect to the line connecting the center point of the sound outlet 109 and the ear hole, it is defined as +, and when the axis of the sound outlet 109 is offset to the right with respect to the line connecting the center point of the sound outlet 109 and the ear hole, it is defined as −.

As shown in FIG. 2, the axis of the sound outlet 109 is offset to the left with respect to the line connecting the center point of the sound outlet 109 and the ear hole, and the offset angle A is 0°-5°. The axis of the sound outlet 109 is offset to the right with respect to the line connecting the center point of the sound outlet 109 and the ear hole, and the offset angle is −5°-0°.

Preferably, the sound outlet 109 is in communication with the cavity and needs to be provided on the end surface 108. The inventor found that, compared to the prior art in which the sound outlet is provided on other components, when the sound outlet 109 is provided on the end surface 108, the sound transmission distance from the sound production apparatus of the present disclosure to the human ear is relatively short, and at the same time, it is possible to reduce the loudness attenuation caused by the distance. Another advantage is that when the sound outlet 109 is on the end surface 108, the sound outlet points to the ear hole of the user. The special position setting of the sound outlet of the present disclosure enables the user to hear a maximum sound. Similarly, using the influence of sound directivity, the sound outlet of the present disclosure points to the ear hole of the user, so that the sound heard by surrounding observers may be reduced, thereby reducing sound leakage.

According to an embodiment of the present disclosure, the smart head-mounted device is provided with a main sound leakage hole 110. Specifically, the arm is provided with a main sound leakage hole 110 and is formed with a cavity in communication with the sound outlet 109. The sound production apparatus is provided inside the cavity, and divides the cavity into a back acoustic cavity and a front acoustic cavity in communication with the sound outlet 109. The main sound leakage hole 110 is in communication with the back acoustic cavity, and the main sound leakage hole 110 and the sound outlet 109 are configured to create an acoustic dipole effect when the sound production apparatus generates sound.

By arranging the sound production apparatus inside the cavity of the arm, an open-coupling between the sound production apparatus and the ear hole of the user is realized. Compared with the closed-coupling of the in-ear earphone, the open-coupling form is convenient and comfortable to wear with a simplified structure and aesthetically pleasing shape; and the user can perceive the external dynamics in real time, which improves the safety when using the smart head-mounted device. However, the shortcomings of this open-coupling are also obvious. As the sound source spreads outward, people around the user will also hear the sound from the sound production apparatus of the smart head-mounted device, which on the one hand is not conducive to protecting the user's personal privacy, and on the other hand, interferes with others. Therefore, in the present disclosure, the sound outlet 109 is opened in the front acoustic cavity, and the main sound leakage hole 110 is opened in the back acoustic cavity at the same time. Since the front acoustic cavity and the back acoustic cavity are respectively located on both sides of the diaphragm of the sound production apparatus, for example, when the diaphragm vibrates towards the front acoustic cavity, the air in the front acoustic cavity is compressed, while the air in the back acoustic cavity just expands. The sound source of the front acoustic cavity (that is, the sound outlet 109) and the sound source of the back acoustic cavity (that is, the main sound leakage hole 110) have opposite phases, and thus form a positive and negative sound pressure phase, which is equivalent to creating an acoustic dipole effect. The so-called acoustic dipole refers to two sound sources that are very close to each other, and have the same vibration amplitude and opposite phases, and a synthesized sound source composed of such two point sound sources is called an acoustic dipole. Based on the anti-phase leakage reduction principle of the acoustic dipole, the smart head-mounted device of the present disclosure enables the sounds emitted by the two sound sources (that is, the sound outlet 109 and the main sound leakage hole 110) to be canceled each other at a distance, so as to achieve the purpose of leakage reduction. Generally, when the distance between the sound outlet 109 and the main sound leakage hole 110 is much smaller than the distance from the above two to the ear holes of the surrounding listeners, the sound outlet 109 and the main sound leakage hole 110 can create the acoustic dipole effect.

In one embodiment, the distance between the main sound leakage hole 110 and the sound outlet 109 is less than 30 mm. For people around the user, the smaller the sound leakage, the better, that is, the effect of an acoustic dipole can be created between the main sound leakage hole 110 and the sound outlet 109, which requires that the distance between the main sound leakage hole 110 and the sound outlet 109 should not be too far. Based on the actual use of the glasses, the inventors found that the effect of eliminating sound leakage is the best when the distance between the main sound leakage hole 110 and the sound outlet 109 is less than 30 mm.

In one embodiment, the distance between the main sound leakage hole 110 and the user's ear hole is greater than the distance between the sound outlet 109 and the user's ear hole. For the user, the anti-phase sound wave of the main sound leakage hole 110 will weaken the loudness of the sound received by the ear. That is to say, the sound wave emitted by the main sound leakage hole 110 will partially cancel the sound wave emitted by the sound outlet 109, thereby affecting the listening effect of the user. In order to reduce this weakening effect, the inventors found that the distance between the main sound leakage hole 110 and the ear needs to be greater than the distance between the sound outlet 109 and the ear.

In one embodiment, the distance between the main sound leakage hole 110 and the user's ear hole is defined as a first distance, the distance between the sound outlet 109 and the user's ear hole is defined as a second distance, and the difference between the first distance and the second distance is greater than 5 mm. The inventors found that when the difference between the above two distances is greater than 5 mm, the sound outlet 109 and the main sound leakage hole 110 do not meet the conditions for creating the sound dipole effect with respect to the user's ear hole, so the impact on the user can be reduced. That is to say, for the people around the user, the sound outlet 109 and the main sound leakage hole 110 create the acoustic dipole effect so as to reduce the sound leakage. The sound outlet 109 and the main sound leakage hole 110 cannot create the acoustic dipole effect, so as not to affect the listening effect of the user.

In one embodiment, the back acoustic cavity is further provided with an auxiliary sound leakage hole 111, and the distance between the auxiliary sound leakage hole 111 and the user's ear hole is greater than that between the main sound leakage hole 110 and the user's ear hole. After the main leakage hole 110 is opened in the back acoustic cavity, two sound sources are actually formed for the user, and since the front acoustic cavity and the back acoustic cavity are different in structure, the two acoustic cavities will form a high-frequency cutoff frequency (FH) at different locations, which causes the frequency response (FR) curve to form a bimodal structure at the high frequency. By adjusting the size of the back acoustic cavity, or adjusting the size and position of the leakage hole, or increasing the leakage hole, the twin peaks can be combined into one. By opening the auxiliary sound leakage hole 111 connected to the back acoustic cavity and adjusting the frequency response (FR) curve of the main sound leakage hole 110 of the back acoustic cavity with the auxiliary sound leakage hole 111, the high frequency cutoff frequency (FH) of the main leakage hole 110 and the high frequency cutoff frequency (FH) of the sound outlet 108 are close to or consistent, thereby improving the sound effect.

In one embodiment, the main sound leakage hole 109 and the auxiliary sound leakage hole 111 are both slit-shaped, and the size of both is not more than 1.5*8 mm, and preferably, the auxiliary sound leakage hole 111 is smaller in size than the main sound leakage hole 110; in other embodiments, the main sound leakage hole 110 and the auxiliary sound leakage hole 111 may also have other shapes, such as a circle.

Optionally, a control button is provided on the arm, and the control button is electrically connected with the sound production apparatus and is configured to control the volume of the sound production apparatus. By providing the control button on the arm, it is convenient for the user to control the volume of the sound production apparatus.

Optionally, the sound production apparatus adopts a moving coil sound production apparatus. The moving coil sound production apparatus can be completely embedded in the arm, so that the smart head-mounted device has a more beautiful appearance and a more concise structure.

Optionally, the frame and arms are made of polymer or metal material. For example, resin materials are used to make the weight of the smart head-mounted device lighter and meet the wearing requirements of the user.

The present disclosure provides a smart head-mounted device, which is simple in structure and light in weight, and meets the wearing requirements of the user; at the same time, in the smart head-mounted device of the present disclosure, the sound production apparatus is provided on the arm to realize the open-coupling between the sound production apparatus and the user's ear hole, so that the smart head-mounted device of the present disclosure not only frees the user's ears, but also has a strong adaptability.

While certain specific embodiments of the present disclosure have been illustrated by way of example, it will be understood by those skilled in the art that the foregoing examples are provided for the purpose of illustration and are not intended to limit the scope of the present disclosure. It will be understood by those skilled in the art that the foregoing embodiments may be modified without departing from the scope and spirit of the disclosure. The scope of the present disclosure is subject to the attached claims.

1. A smart head-mounted device for a user, comprising:
at least one lens and at least one arm; the arm comprising a fixed section and a cooperating section, the fixed section being connected to the lens at a first end thereof, the cooperating section being formed as an extension of the fixed section from a second end thereof, the cooperating section having a curvature and configured to hang on an ear of the user; and
a sound production apparatus provided inside the fixed section, the sound production apparatus being provided with a sound outlet, at least a part of a structure of the sound outlet facing an area surrounded by the cooperating section, and the sound outlet configured to guide a sound out of the sound production apparatus;
the sound outlet positioned to avoid direct contact with the ear of the user and set apart from an ear hole of the user by a predetermined distance when the user wears the smart head-mounted device, the predetermined distance being greater than or equal to 0.5 cm.

2. The smart head-mounted device of claim 1, wherein the predetermined distance ranges from 0.5 cm to 0.6 cm.

3. The smart head-mounted device of claim 2, wherein the predetermined distance ranges from 2 cm to 4 cm.

4. The smart head-mounted device of claim 1, wherein the fixed section has a longitudinal height greater than that of the cooperating section, with an end surface formed at one end thereof close to the cooperating section for smooth connection with the cooperating section.

5. The smart head-mounted device of claim 4, wherein the sound outlet is selected from the group consisting of a strip-shaped slit, with at least a part of the sound outlet extending to the end surface;
a round hole, and an oval hole.

6. The smart head-mounted device of claim 1, wherein an axis of the sound outlet is configured to form an angle ranging from 0°to 5° measured from a line connecting a center point of the sound outlet and the ear hole.

7. The smart head-mounted device of claim 1, wherein the fixed section is formed with a cavity therein, the cavity is in communication with the sound outlet and is provided with the sound production apparatus inside; the sound production apparatus divides the cavity into a back acoustic cavity and a front acoustic cavity in communication with the sound outlet, and the back acoustic cavity is provided with a sound-adsorbing material inside.

8. The smart head-mounted device of claim 1, wherein the arm is provided with a main sound leakage hole and is formed with a cavity therein, the cavity is in communication with the sound outlet and is provided with the sound production apparatus inside; the sound production apparatus divides the cavity into a back acoustic cavity and a front acoustic cavity in communication with the sound outlet, and the main sound leakage hole is in communication with the back acoustic cavity.

9. The smart head-mounted device of claim 8, wherein the main sound leakage hole is positioned in the arm such that a distance between the main sound leakage hole and the ear hole of the user of the smart head-mounted device is greater than a distance between the sound outlet and the ear hole of the user.

10. The smart head-mouthed device of claim 8, wherein the arm is further provided with an auxiliary sound leakage hole in communication with the back acoustic cavity, and the auxiliary sound leakage hole is positioned in the arm such that a distance between the auxiliary sound leakage hole and the ear hole of the user of the smart head-mounted device is greater than the distance between the main sound leakage hole and the ear hole of the user.
